(19) United States
(12) Patent Application Publication
(10) Pub. No.: US 2007/0245342 A1
(43) Pub. Date: Oct. 18, 2007

(54) Apparatus and method for installing software

(75) Inventors: Won-chang Lee, Suwon-si (KR); Jae-seong Im, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/604,330

(22) Filed: Nov. 27, 2006

(30) Foreign Application Priority Data
Jan. 4, 2006 (KR) 2006-1018

(51) Int. Cl. G06F 9/445

(52) U.S. Cl. 717/174

(57) ABSTRACT

An apparatus and method for installing software which can be used to manufacture various types of computers according to user preference and shorten the manufacturing time, the apparatus including a software storage unit having multiple partitions storing different provided software items according to types of the provided software items; a software selection unit selecting predetermined software items from the stored software items; and a control unit installing the selected software items in a predetermined partition of the software storage unit.

### CROSS-REFERENCE TO RELATED APPLICATION

This application claims from the benefit of Korean Patent Application No. 2006-1018 filed on Jan. 4, 2006 in the Korean Intellectual Property Office, the disclosure of which is incorporated herein by reference.

### BACKGROUND OF THE INVENTION

1. Field of the Invention

Aspects of the present invention relate to an apparatus and method for installing software, and more particularly, to an apparatus and method for installing software, which can be used to manufacture various types of computers according to user preference and shorten the manufacturing time.

2. Description of the Related Art

Generally, when computers are purchased, hardware and software installed in the hardware are purchased together. The software installed in the hardware usually includes various types of software, such as an operating system, drivers for various devices, application programs, network software programs to control a network, etc.

FIG. 1 is a flowchart of a conventional Build-To-Plan (BTP) method of manufacturing a computer. As shown, a computer manufacturer estimates the demand for computers (operation S11) and then determines specifications of hardware and software of each computer through various analyses (operation S12). Then, the computer manufacturer manufactures, buys, or otherwise obtains the hardware and software according to the determined specifications (operation S13), and installs the software in the hardware (operation S14), thereby completing one computer model.

The method as shown FIG. 1 is called a BTP method. In the BTP method, a predetermined number of computers are manufactured according to predetermined specifications and the manufactured computers are then sold to users. However, the computers manufactured according to the BTP method may result in a user purchasing a computer equipped with software that the user does not want. That is, the BTP method provides a narrow width of selection to a computer user who wants to purchase a computer equipped with specific software having specifications that the user wants, and is thus unable to satisfy tastes of various users. Therefore, there has been a demand for a method by which a user can purchase a computer equipped with specific software having specifications that the user wants.

FIG. 2 is a flowchart of a conventional Configure-To-Order (CTO) method of manufacturing a computer. As shown, a computer manufacturer estimates a current demand for computers (operation S21) and then determines specifications of hardware and software of each computer through various analyses (operation S22). Then, the computer manufacturer manufactures, purchases, or otherwise obtains the hardware according to the determined specifications (operation S23), so that the user can select hardware with various specifications (operation S24). The user can select the hardware either off-line or on a webpage of the computer manufacturer through a network. Meanwhile, the computer manufacturer manufactures, purchases, or otherwise obtains the software according to the determined specifications (operation S25), and the user connects to the webpage of the computer manufacturer through a network and selects software which the users wants (operation S26). At this time, the user can select various types of software items, including an operating system, device drivers for various devices, various application programs, etc. After the selection by the user has been completed as described above, the computer manufacturer installs the software selected by the user in the selected hardware, thereby completing one computer model (operation S27). Currently, the DELL company of the U.S.A. sells computers through this method.

The Configure-To-Order (CTO) method of FIG. 2 shows a higher flexibility in computer products than the BTP method of FIG. 1, described above. However, the CTO method has a lower productivity in the manufacturing line than the BTP method. Therefore, there has been a request for a method which can achieve both the production speed of the BTP method and the product flexibility of the CTO method.

Korean Laid-Open Patent No. 2005-0048320 discloses an apparatus and a method by which a user can download software through a network and automatically install the software in real time in the user's computer. By the disclosed apparatus and method, even a user who is inexperienced with software can upgrade and restore the software in accordance with the user's hardware in a convenient manner. However, there has not been a proposed method that can satisfy both the manufacturing speed of the BTP method and the product flexibility of the CTO method.

### SUMMARY OF THE INVENTION

Accordingly, aspects of the present invention are provided to solve the above-mentioned problems occurring in the prior art, and an object of the present invention is to provide an apparatus and method for installing software, in which software is stored in different partitions according to characteristics and installation methods for the software, and software corresponding to a model or user preference of each product are selectively installed.

According to an aspect of the present invention, there is provided an apparatus for installing software, the apparatus including a software, storage unit having one or more partitions to store different provided software items according to types of the provided software items; a software selection unit to selected predetermined software items from the stored software items; and a control unit to install the selected software items in a predetermined partition of the software storage unit.

According to another aspect of the present invention, there is provided a method of installing software, the method including storing different provided software items in one or more partitions according to types of the provided software items; selecting predetermined software items from the stored software items; and installing the selected software items in a predetermined partition.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a conventional BTP method of manufacturing a computer;

FIG. 2 is a flowchart of a conventional CTO method of manufacturing a computer;

FIG. 3 is a block diagram of a software-installing apparatus according to an embodiment of the present invention;

FIG. 4 illustrates a structure of a software storage unit according to an embodiment of the present invention;

FIG. 5 is a view illustrating a method of manufacturing a software storage unit according to an embodiment of the present invention; and

FIG. 6 is a flowchart of a method of installing software according to an embodiment of the present invention.

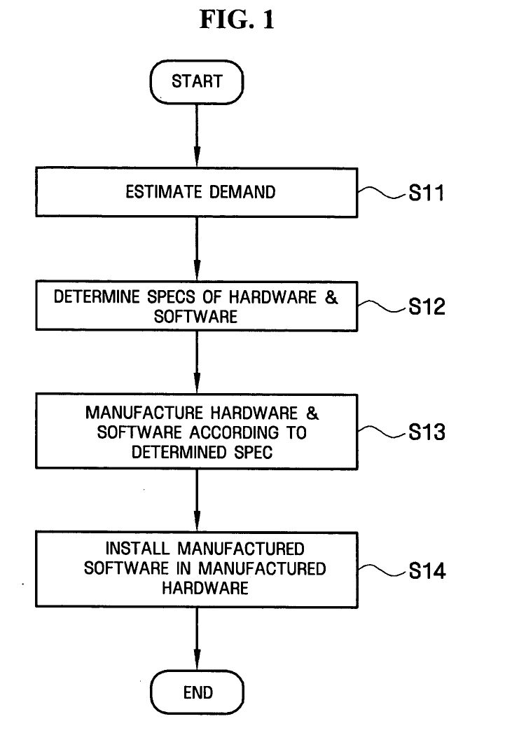

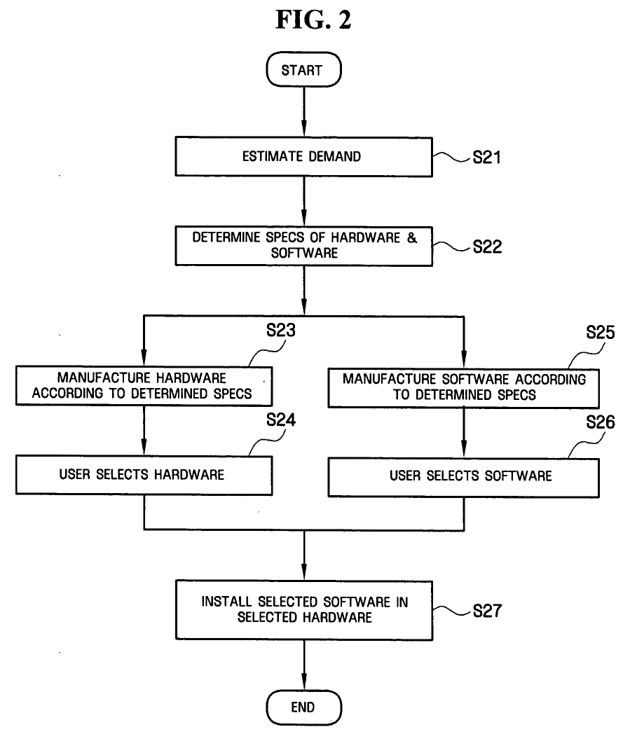

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to block diagrams or flowcharts illustrating apparatuses and methods for transmitting an event in a web-based system according to embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create methods to implement the functions specified in the flowchart block or blocks. These computer program instructions may also be stored in a computer-usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide methods to implement the functions specified in the flowchart block or blocks.

Furthermore, each block of the flowchart illustrations may represent a module, segment, or portion of code, which includes one or more executable instructions to implement the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. Hereinafter, preferred embodiments of the present invention will be described with reference to the accompanying drawings.

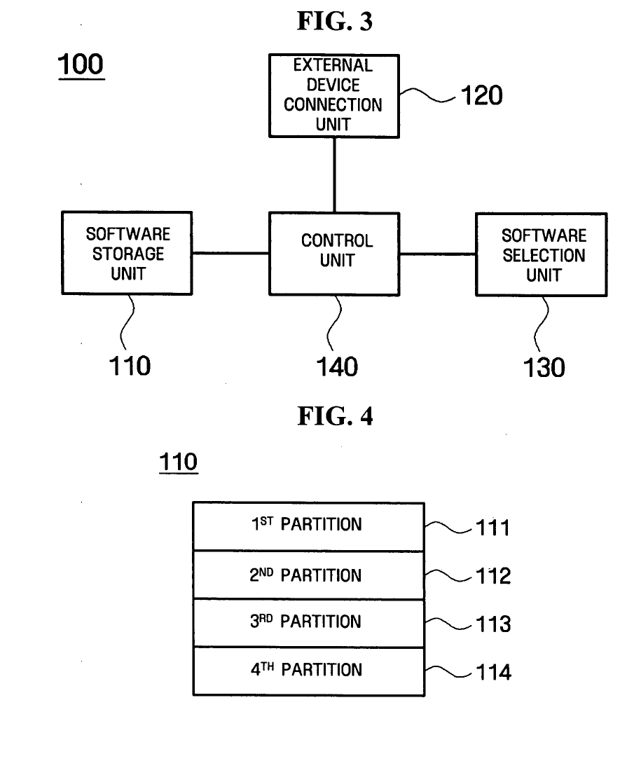

FIG. 3 is a block diagram of a software-installing apparatus according to an embodiment of the present invention. The software-installing apparatus according to an embodiment of the present invention may be a computer manufactured by a computer manufacturer. It is understood that the computer may be a desktop computer, a server, a laptop or notebook computer, a personal digital assistant, a mobile device, or any programmable or executing data processing apparatus.

As shown, the software-installing apparatus 100 according to an embodiment of the present invention includes a software storage unit 110, an external device connection unit 120, a software selection unit 130, and a control unit 140. The software storage unit 110 is a large capacity storage medium mounted in a computer, such as a Hard Disk Drive (hereinafter, referred to as “HDD”), in which various applications including an operating system, device drivers, etc. are installed. It is understood that the software storage unit 110 may be an external storage device, or an optical drive, according to other aspects. According to an embodiment of the present invention, the software storage unit 110 is divided into a plurality of partitions. The software storage unit 110 may be manufactured by the computer manufacturer to have the partitions.

For example, according to the present embodiment as shown in FIG. 4, the software storage unit 110 includes first, second, third, and fourth partitions 111, 112, 113, 114. The first partition 111 has various software items for operation of the computer. The second partition 112 has an operating system for each computer model manufactured by a computer manufacturer. The third partition 113 has device drivers and various applications for each computer model manufactured by a computer manufacturer. The fourth partition 114 has a Host Protected Area (HPA). Although the shown embodiment is based on an example in which the software storage unit 110 is divided into four partitions, this is just in order to help an understanding of the present invention and the number of divided partitions and the software stored in each partition may be different according to other aspects.

The software storage unit 110 may be mass-produced through copying by the computer manufacturer. For example, the computer manufacturer may mass-produce HDDs each having four partitions by copying a master HDD having four divided partitions. In the second partition 112 and the third partition 113, the operating system, device drivers, and various applications for each computer model are stored. Therefore, it is possible to simplify the manufacturing process by copying the software storage unit 110 from the master HDD instead of separately manufacturing the software storage unit 110 and separately installing the above-described applications, drivers, operating systems, etc. for each computer model.

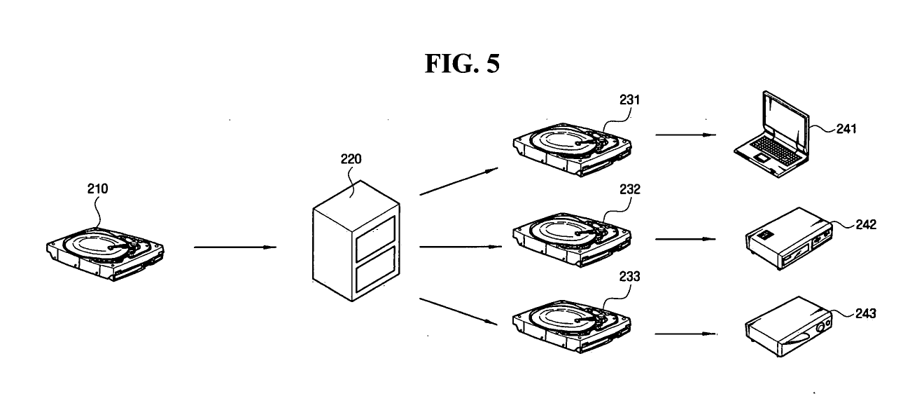

Specifically, as shown in FIG. 5, the master HDD 210 includes the first partition 111, the second partition 112, the third partition 113, and the fourth partition 114. The computer manufacturer produces a plurality of copied HDDs 231, 232, and 233 from the master HDD 210 by using a copy device 220, and installs the copied HDDs 231, 232, and 233 in computer models 241, 242, and 243, respectively. Each of the installed copied HDDs 231, 232, and 233 can be understood as the software storage unit 110.

Meanwhile, the fourth partition 114 corresponds to a predetermined reserved area used for a specific application regardless of the operating system. For example, the fourth partition 114 may be used for an application, such as “FirstWare Recover Pro” of the Phoenix company, which is a backup/protection solution for automatically protecting an operating system, applications, data, etc. of the user's computer. Further, although the present embodiment is based on an example in which the fourth partition 114 is an HPA area, this is not restrictive and the fourth partition 114 may be set as either a software-storing area as are the first to third partitions 111, 112, and 113, or a hidden area.

The external device connection unit 120 is connected either to a network or to an external device, such as a Compact Disc Read Only Memory (CD-ROM), Digital Versatile Disc Read Only memory (DVD-ROM) or a Floppy Disk Drive (FDD), so that a user (which may be a computer-selling company) can receive a list of selected software items through the external device connection unit 120. In other words, the user or computer-selling company can recognize an available software list provided by the computer manufacturer through, for example, a webpage or brochure of the computer manufacturer, select software items which the user wants to install in the computer from the available software list, and then request the computer manufacturer to provide a list of the selected software items through a storage medium inserted in the external device or through the network. It is understood that a software item may be any of a software title, a driver, an operating system, an application program, or any executable or processable programming code.

The external device connection unit 120 may include various interfaces, such as Bluetooth, USB, and IEEE 1394. According to the shown embodiment, the computer manufacturer stores the list of selected software items requested by the user or the computer-selling company in a predetermined storage medium (such as an FDD or a CD). The user may receive the stored list of selected software items through the external device connection unit 120.

The software selection unit 130 selects software items in the list of selected software items, requested, for example, by the user or the computer-selling company, from software items stored in the software storage unit 110. For example, the list of selected software items may include specific information given to each software item, and each software item stored in the software storage unit 110 may be also given the same specific information as that in the list of selected software items. Then, the software selection unit 130 selects software items having the same specific information as that in the list of selected software items from the software storage unit 110.

The control unit 140 installs the software items selected by the software selection unit 130 in the first partition 111 of the software storage unit 110. For example, the control unit 140 may extract a selected operating system from the second partition 112 and install it in the first partition 111, and may extract selected device drivers and various application programs and install them in the first partition 111. However, it is understood that the control unit 140 may install the software items in another partition, or a plurality of partitions, according to other aspects. This installation process is repeatedly performed until all software items included in the list of selected software items are completely installed.

When all the software items included in the list of selected software items are completely installed, the control unit 140 deletes the second partition 112 and the third partition 113 and expands the area of the first partition 111 by an amount equal to the areas of the deleted partitions. After the control unit 140 completes installation of all the software items included in the list of selected software items, the operating system, device drivers and application programs stored in the second partition 112 and the third partition 113 are not necessary any more. Therefore, the second partition 112 and the third partition 113 are deleted, while the area of the first partition 111 is expanded. In the present embodiment, the control unit 140 deletes the second partition 112 and the third partition 113 and does not delete the fourth partition 114, because the fourth partition 114 is an HPA area. However, when the fourth partition 114 is not the HPA area but is an ordinary partition which is a non-protected area, the fourth partition 114 may also be deleted.

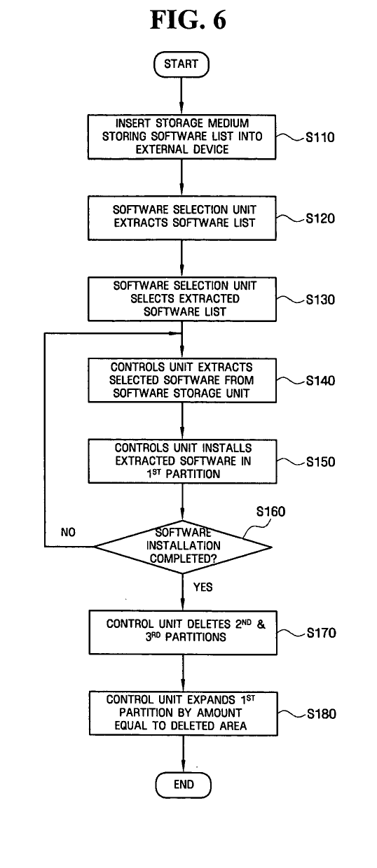

FIG. 6 is a flowchart of a method of installing software according to an embodiment of the present invention. In the method of installing software according to the present embodiment as shown, a computer manufacturer inserts a storage medium storing a list of selected software items in an external device connected through the external device connection unit 120 to the computer (operation S110). The external device may be connected through a wireless or wired connection to the computer. However, it is understood that, according to other aspects, the list of selected software items may be stored in an internal software storage unit, such as the software storage unit 110, and/or, for example, in a Host Protected Area of a partition of the software storage unit 110. At this time, the computer may use a minimum operating system, such as WinPE, which is a minimum Win32 operating system including a limited service made in a kernel of the Windows XP professional operating system, in order to perform booting, recognize the external device, receive the list of selected software items from the external device, extract software items from the software storage unit 110 based on the received list of selected software items, and then install the extracted software items.

The minimum operating system may be stored either in a separate partition arranged in the software storage unit 110 in order to boot the computer, or in an external storage medium such as CD or FDD, so that the computer can be booted by an external device. Further, the separate partition arranged in the software storage unit 110 for the minimum operating system can also be deleted after the installation of the requested software is completed.

Further, although the list of selected software items may be stored in a storage medium inserted in the external device in the present embodiment, the user, which may be a computer-selling company, may receive the list of selected software items through a network connected to the computer.

The software selection unit 130 extracts the list of selected software items from the storage medium inserted in the external device (operation S120), and selects software items included in the extracted list of selected software items from the operating system, device drivers and various application programs stored in the second partition 112 and the third partition 113 (operation S130).

The control unit 140 extracts the software items selected by the software selection unit 130 from the second partition 112 and the third partition 113 (operation S140), and installs the extracted software items in the first partition 111 (operation S140).

Thereafter, the control unit 140 determines if all the software items included in the list of selected software items have been installed (operation S160), and repeats extraction of the software items from the second partition 112 and the third partition 113 and installation of the extracted software in the first partition 111 (operations S140 and S150) until all the software items included in the list of selected software items are installed.

When all the software items included in the software list have been installed, the control unit 140 deletes the second partition 112 and the third partition 113 (operation S170), and expands the area of the first partition 111 by an amount equal to the areas of the deleted second and third partitions 112 and 113. After the control unit 140 completes installation of all the software included in the list of selected software items, the operating system, device drivers and application programs stored in the second partition 112 and the third partition 113 are not necessary any more. Therefore, the second partition 112 and the third partition 113 are deleted, while the area of the first partition 111 is expanded. In the present embodiment, the control unit 140 deletes the second partition 112 and the third partition 113 and does not delete the fourth partition 114, because the fourth partition 114 is an HPA area. However, when the fourth partition 114 is not the HPA area but is an ordinary partition which is a non-protected area, the fourth partition 114 may also be deleted.

As used herein, the “unit” or “module” refers to a software element or a hardware element, such as a Field Programmable Gate Array (FPGA) or an Application Specific Integrated Circuit (ASIC), which performs a predetermined function. However, the unit or module does not always have a meaning limited to software or hardware. The module may be constructed either to be stored in an addressable storage medium or to execute one or more processors. Therefore, the module includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the modules may be either combined into a smaller number of elements or modules or divided into a larger number of elements or modules.

In the apparatus and method of installing software according to the present invention as described above, all software necessary for each computer model are pre-stored together in a single storage medium, and only the software items requested by a user or a computer-selling company are selectively installed in the computer. Therefore, the present invention can improve the productivity and product flexibility of the computer.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for installing software, the apparatus comprising:
a software storage unit comprising one or more partitions to store provided software items according to types of the provided software items;
a software selection unit to select predetermined software items from the stored software items; and
a control unit to install the selected software items in a predetermined partition of the software storage unit.

2. The apparatus as claimed in claim 1, wherein the one or more partitions comprise:
a pre-storage partition to pre-store the provided software items; and
an installation partition in which the selected software items, selected from the stored software items by the software selection unit, are installed.

3. The apparatus as claimed in claim 2, wherein the one or more partitions further comprise a protected partition that is a Host Protected Area.

4. The apparatus as claimed in claim 2, wherein the control unit extracts the selected software items from the pre-storage partition and installs the extracted software items in the installation partition.

5. The apparatus as claimed in claim 1, wherein a first partition, of the one or more partitions, stores one or more application programs, a second partition stores one or more operating systems, and a third partition stores device drivers.

6. The apparatus as claimed in claim 1, wherein the software selection unit receives a list of the predetermined software items and selects the predetermined software items according to the list.

7. The apparatus as claimed in claim 6, further comprising an external device connection unit connected to an external device that transmits the list of the predetermined software items selected by the software selection unit.

8. The apparatus as claimed in claim 6, wherein the software selection unit selects software items included in the list of the predetermined software items from the software storage unit.

9. The apparatus as claimed in claim 7, wherein the external device connection unit receives the list of the predetermined software items, through a network, from the external device and then transmits the received list of the predetermined software items to the software selection unit.

10. The apparatus as claimed in claim 6, wherein the software storage unit stores the list of the predetermined software items.

11. The apparatus as claimed in claim 4, wherein, after installing the selected software items, the control unit deletes the pre-storage partition and expands the installation partition by an amount equal to an area of the deleted pre-storage partition.

12. A method of installing software, the method comprising:
storing provided software items in one or more partitions of a software storage unit according to types of the provided software items;
selecting predetermined software items from the stored software items; and
installing the selected software items in a predetermined partition of the software storage unit.

13. The method as claimed in claim 12, wherein:
the storing of the provided software items comprises storing the provided software items in a pre-storage partition of the one or more partitions; and
the installing of the selected software items comprises installing the selected software items, stored in the pre-storage partition, in an installation partition of the one or more partitions.

14. The method as claimed in claim 13, wherein the installing of the selected software items further comprises:
extracting the selected software items from the pre-storage partition; and
installing the extracted software items in the installation partition.

15. The method as claimed in claim 12, wherein the storing of the provided software items comprises:
storing one or more application programs in a first partition;
storing one or more operating systems in a second partition; and
storing device drivers in a third partition.

16. The method as claimed in claim 12, further comprising:
receiving a list of the predetermined software items before the selecting of the predetermined software items.

17. The method as claimed in claim 16, wherein the receiving of the list of the predetermined software items comprises receiving the list of the predetermined software items from an external device.

18. The method as claimed in claim 16, wherein the selecting of the predetermined software items comprises selecting software items included in the received list of the predetermined software items from the one or more partitions.

19. The method as claimed in claim 17, wherein the receiving of the list of the predetermined software items comprises receiving the list of the predetermined software items from the external device through a predetermined network.

20. The method as claimed in claim 16, further comprising storing the list of the predetermined software items.

21. The method as claimed in claim 14, wherein the installing of the selected software items comprises:
deleting the pre-storage partition after installing the selected software items; and
expanding the installation partition by an amount equal to an area of the deleted pre-storage partition.

22. The method as claimed in claim 12, wherein the predetermined software items are selected by a user from a list of the provided software items.

23. A method of installing software, the method comprising:
selecting one or more software items from a list of available software items;
storing the available software items in a storage unit;
identifying the selected one or more software items from the stored software items; and
installing the identified software items in the storage unit using the stored software items.

24. The method as claimed in claim 23, wherein the storing of the available software items comprises storing the available software items in one or more partitions of the storage unit according to types of the provided software items.

25. The method as claimed in claim 24, wherein:
the storing of the available software items further comprises storing the available software items in a pre-storage partition, of the one or more partitions; and
the installing of the identified software items comprises installing the identified software items, stored in the pre-storage partition, in an installation partition, of the one or more partitions.

26. The method as claimed in claim 25, wherein the installing of the identified software items further comprises:
extracting the identified software items from the pre-storage partition; and
installing the extracted software items in the installation partition.

27. The method as claimed in claim 24, wherein the storing of the available software items further comprises:
storing one or more application programs in a first partition;
storing one or more operating systems in a second partition; and
storing device drivers in a third partition.

28. The method as claimed in claim 23, further comprising:
receiving a list of the selected one or more software items before the identifying of the selected one or more software items.

29. The method as claimed in claim 28, wherein the receiving of the list of the selected one or more software items comprises receiving the list of the selected one or more software items from an external device.

30. The method as claimed in claim 28, wherein the identifying of the selected one or more software items comprises identifying software items included in the received list of the selected one or more software items from the stored available software items.

31. The method as claimed in claim 29, wherein the receiving of the list of the selected one or more software items comprises receiving the list of the selected one or more software items from the external device through a predetermined network.

32. The method as claimed in claim 28, further comprising storing the list of the one or more selected software items in the storage unit.

33. The method as claimed in claim 23, further comprising:
storing a list of the selected one or more software items in the storage unit.

34. The method as claimed in claim 33, wherein the identifying of the selected one or more software items comprises identifying software items included in the stored list of the selected one or more software items from the stored available software items.

35. The method as claimed in claim 26, wherein the installing of the identified software items comprises:
deleting the pre-storage partition after installing the identified software items; and
expanding the installation partition by an amount equal to an area of the deleted pre-storage partition.

36. The method as claimed in claim 23, wherein the storage unit is comprised in a computer and the list of available software items is provided on a webpage and/or a brochure of a manufacturer of the computer.

37. A method of manufacturing a plurality of software storage units for a plurality of software processing apparatuses, the method comprising:
storing provided software items in one or more partitions of a master storage unit according to types of the provided software items;
copying the master storage unit to the plurality of storage units to have the one or more partitions storing the provided software items;
installing the plurality of storage units into the respective plurality of software processing apparatuses; and
identifying one or more software items, for each of the plurality of software processing apparatuses, selected by a user of each of the respective plurality of software processing apparatuses from the stored software items, and installing in each of the plurality of software processing apparatuses the identified one or more software items from the one or more partitions.

38. The method as claimed in claim 37, wherein:
the one or more partitions comprises one or more pre-storage partitions to store the provided software items and an installation partition in which the identified one or more software items are installed; and
the identifying of the one or more software items comprises:
deleting the one or more pre-storage partitions after installing the identified one or more software items; and
expanding the installation partition by an amount equal to an area of the deleted one or more pre-storage partitions.
